(19) United States
(12) Patent Application Publication
(10) Pub. No.: US 2004/0128513 A1
(43) Pub. Date: Jul. 1, 2004

(54) Secured electronic document and method of validating the same

(76) Inventors: Yen-Hsing Wu, Taipei (TW); Tung-Lin Wu, Taoyuan Hsien (TW); Chih-Chieh Lin, Taipei (TW)

Correspondence Address: WOLF GREENFIELD & SACKS, PC, FEDERAL RESERVE PLAZA, 600 ATLANTIC AVENUE, BOSTON, MA, 02210-2211, US

(21) Appl. No.: 10/373,904

(22) Filed: Feb. 25, 2003

(30) Foreign Application Priority Data
Dec. 25, 2002 (TW) 091137276

(51) Int. Cl. H04L 9/00; H04N 7/167

(52) U.S. Cl. 713/176; 380/201

(57) ABSTRACT

The present invention relates to a secured electronic document and method of validating the same. A security key is generated when the electronic document is generated and a printer driver is invoked to print out the encrypted document, and the security key is saved to a key manager over the network. When the secured electronic document or encrypted document is circulated to other persons or downstream processing units, the document recipients can request the security key from the key manager through the network link to check whether the encrypted document is the original copy. The security key may contain the document identification number, the serial number of the printer, the printer profile or printing status.

### BACKGROUND OF THE INVENTION

1. Field of the Invention

The present invention relates to a secured electronic document and method of validating the same, in particular to a method of validating whether the encrypted document is the original copy.

2. Description of Related Arts

Under the directives to boost the operation efficiency and inter-departmental communication in the government offices, electronic documents are increasingly used by all levels of the government whether in transferring data files or message exchange.

In general, important data files are digitally encrypted with security information of variable length to prevent illegal duplication or tampering with the data. The encrypted data file can then be transferred to the destination over the Internet. The recipient of the data file only has to decode the document to restore the original format.

In certain circumstances, for example in legal offices and courts, a document has to be presented in conventional print to order to take legal effect. An ordinary data file can be printed out by an ink jet printer or a laser printer onto a hard copy, but it will be difficult to determine whether the document is the original copy with the current printing technology. The problem of validation is one of the main reasons deterring wider use of the electronic document.

In past years, a method of validating encrypted documents had been proposed, but it only went so far to confirm that secured electronic document can be printed out with encryption, without mentioning how to determine whether the printed document is the original copy. Another method was related to the secured printing of the electronic document and tracking of the distribution path of the document after printing. Still another method, as shown in FIG. 4, employed digital encryption with a template and document layout for embedding watermarking in images, data, and graphic patterns. Different scanning methods are required for validating the printed data and graphic output. However, none of them have given further details on how to validate a printed document as the original copy in order to prevent illegal duplication of the document.

### SUMMARY OF THE INVENTION

The main object of the present invention is to provide a secured electronic document and a means of validating whether the encrypted document is the original copy, so as to prevent illegal duplication of the document. A security key is embedded in the data file when it is converted to corresponding printer commands, and a copy of the key is simultaneously saved to a key manager through the network link for subsequent use in validation of the document.

When the encrypted document is circulated to downstream users or processing units, the recipient of the document can request the security key from the key manager over the network to check whether the encrypted document is the original copy.

The above mentioned encryption for the electronic document can be incorporated with security information such as the identification number, the serial number of the printer, the printer profile or printing status in the printer commands, so that the security information will be printed out in form of bar codes or watermarking on a hard copy.

The document identification number can be created when the electronic document is sent out by the document sender.

The serial number of the printer is given by the printer manufacturer.

The printer profile is registered in the firmware of the printer, including printer control data such as the switching frequency of the print head, the dot resolution, the serial number of the printing paper, and the total output pages of the printer.

This security information can also be used alone or in combination to produce a compound key.

To encrypt an electronic document, in accordance with the invention, the printer driver is first invoked for converting the electronic document to a printable form, and then a security key containing information with regard to the electronic document and the printer is saved to a key manager over the network. The recipient of the encrypted document downstream can request the security key corresponding to the electronic document from the key manager through the network link. The security information contained in the key is then read by an appropriate means and compared with the corresponding information printed out on the hardcopy. If they match with each other, it can be confirmed that encrypted document is validated to be the original copy; otherwise, it is only a duplicated copy.

### BRIEF DESCRIPTION OF THE DRAWINGS

FIG. 1 is the system architecture of document validation in accordance with the present invention;

FIG. 2 is a block diagram of the encoding process for the encrypted document;

FIG. 3 is a block diagram of the decoding process for the decrypted document; and

FIG. 4 is a flow chart of a convention encryption process for a data file.

### DETAILED DESCRIPTION OF THE PREFERRED EMBODIMENT

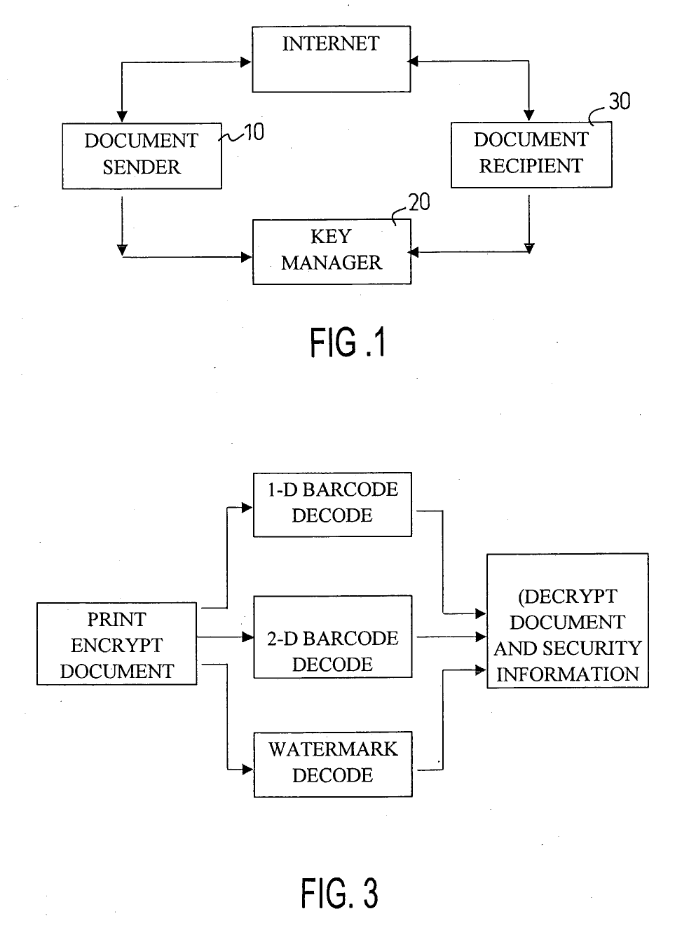

The present invention provides a secured electronic document and a method of validating the same. FIG. 1 shows the system architecture of the document validation. When an electronic document is generated by a document sender (10), a security key containing the document identification number is simultaneously saved to a key manager (20) for user validation of the document in subsequent requests. When the data file is distributed to a document recipient (30) through a network link, and the printer driver is invoked by the document recipient (30) to print out the data file, another set of security keys containing the printer profile and printing status is sent to the key manager (20) and added to the original security information. After the encrypted document is printed out on a hard copy, the document may be passed to other persons or government units that have to make decisions or take certain actions basing upon the encrypted document. To test the authenticity of the encrypted document, they have to find out whether the document is the original copy, which may be accomplished by sending a request to the key manager (20) through the network link requesting for the security key corresponding to the encrypted document.

Using the government administrative office as an example in the preferred embodiment of the invention, the above mentioned document sender (10) of the electronic document can be initiated by any level of the government units; the key manager (20) may represent a nation-wide data center; and the document recipient (30) may be any person of the general public or any level of the government units.

When an electronic document is generated by the document sender (10), a set of security keys containing a document identification number is generated, which is generated by the government administrative office to prevent illegal duplication of the document and tampering with the data. The electronic document or data file is received over the Internet by the document recipient (30), represented by a natural person or another government unit. To present a secured document in printed form, the document has to be embedded with a security key containing one of the document identification number, the serial number of the printer, the printer profile or printing status.

For the serial number of the printer, each printer has a unique number given by the manufacturer which is stored in the ROM memory. Another serial number can be encoded with the MAC code address on an ordinary Ethernet card, which is created by the network card manufacturer basing on the output volume of the card and the serial number of the chip set identification number using the MAC coded address.

The manufacturer of a printer can establish a global distribution center, so that a unique number can be assigned for each kind of printer. The manufacturer then creates another serial number for each printer manufactured. After combining these two numbers, a compound serial number is generated for each output printer. This compound serial number is unique and relates to a specific printer in the whole world.

For the printer profile, in order to have the electronic document printed out on a hard copy, the printer driver is invoked. Data contained in the document are first converted to printer commands, and the security information that needs to be embedded in the printer commands is retrieved from the printer control firmware (40), such as the switching frequency of the print head, the dot resolution, the serial number of the printing paper, and the total output pages by the printer. The total output pages are to represent the accumulated number of pages that are output by the printer ever since the printer is manufactured.

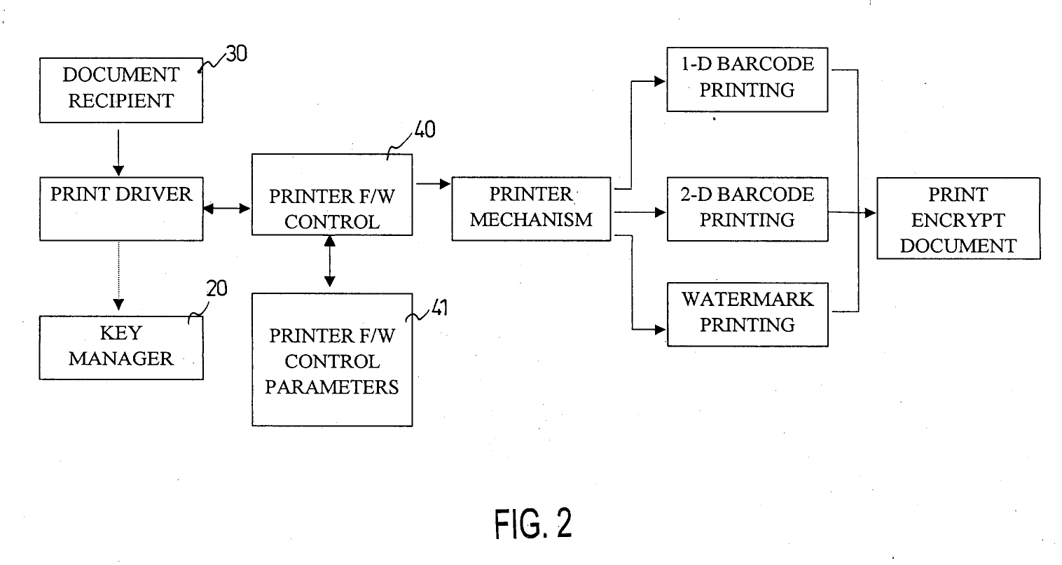

FIG. 2 shows the encoding process of the encrypted electronic document in accordance with the invention. When the printer driver is invoked by the document recipient (30), the printer control parameters (41) such as the total output pages, number of print heads, and the dot resolution are retrieved from in the printer control firmware (40), and this information is passed to the requesting printer driver through IEEE1284 or USB data cables, and this information is merged with the uni-dimensional bar codes, two-dimensional bar codes or watermarking to be printed out on the hard copy of the document. The electronic document is converted to printer machine language according to the print color or half tone, incorporating the machine serial number, document identification and the printer profile. The document is passed to the printer control firmware (40) through the data bus to create an encrypted document, which is then printed out by the printer that decodes the printer commands. At the same time, the printer driver will send the security information containing the printer serial number and the printer profile to the key manager (20) for user validation of the electronic document.

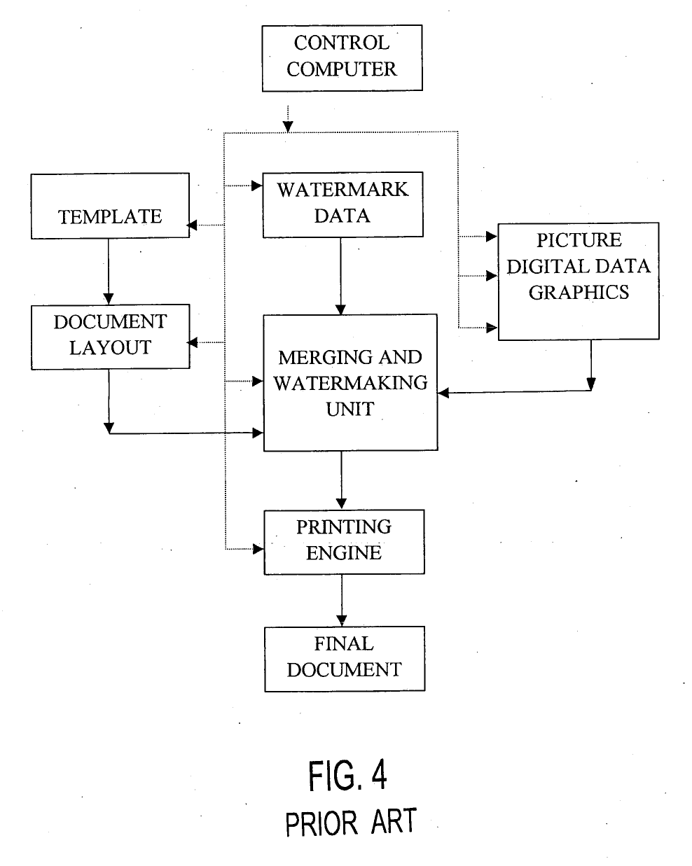

When other downstream users receive the encrypted document, as shown in FIGS. 3 and 4, the document recipient (30) can request the security key corresponding to the encrypted document from the key manager (20) to check whether it is the original copy. If the data in the security key perfectly matches those on the printed document, it can be determined that the document is the original copy issued by the document sender (10).

The above mentioned methods of creating a secured electronic document by embedding security information in the bar codes and watermarking and subsequent validation of the encrypted document by downstream users are able to prevent illegal duplication of the document or tampering with the document data. The invention has been described with reference to a preferred embodiment. It will be appreciated that variations can be effected by an ordinary person skilled in the art without departing from the scope of the invention.

What is claimed is:

1. A method of validating an encrypted document comprising embedding of security information in the electronic document that can be securely printed on a hard copy, and a security key containing important security information is simultaneously saved to a key manager over the network when printing the document, which will be used in subsequent validation to determine whether the printed copy of the document is the original one.

2. The method of validating an encrypted document as claimed in claim 1, wherein the security key is a document identification number given by the document sender.

3. The method of validating an encrypted document as claimed in claim 1, wherein the security key is a serial number of the printer carrying out the printing job.

4. The method of validating an encrypted document as claimed in claim 1, wherein the security key is the printer profile of a printer.

5. The method of validating an encrypted document as claimed in claim 4, wherein the printer profile may include the frequency of switching of the print head, the dot resolution, the serial number of the printing paper, and the total output pages.

6. The method of validating an encrypted document as claimed in claim 2, wherein the security key can be merged with the printer commands to be printed out in the form of uni-dimensional bar codes.

7. The method of validating an encrypted document as claimed in claim 3, wherein the security key can be can be merged with the printer commands to be printed out in the form of uni-dimensional bar codes.

8. The method of validating an encrypted document as claimed in claim 4, wherein the security key can be merged with the printer commands to be printed out in the form of uni-dimensional bar codes.

9. The method of validating an encrypted document as claimed in claim 5, wherein the security key can be merged with the printer commands to be printed out in the form of uni-dimensional bar codes.

10. The method of validating an encrypted document as claimed in claim 2, wherein the security key can be merged with the printer commands to be printed out in the form of two-dimensional bar codes.

11. The method of validating an encrypted document as claimed in claim 3, wherein the security key can be merged with the printer commands to be printed out in the form of two-dimensional bar codes.

12. The method of validating an encrypted document as claimed in claim 4, wherein the security key can be merged with the printer commands to be printed out in the form of two-dimensional bar codes.

13. The method of validating an encrypted document as claimed in claim 5, wherein the security key can be merged with the printer commands to be printed out in the form of two-dimensional bar codes.

14. The method of validating an encrypted document as claimed in claim 2, wherein the security key can be merged with the printer commands to be printed out in the form of watermarking.

15. The method of validating an encrypted document as claimed in claim 3, wherein the security key can be merged with the printer commands to be printed out in the form of watermarking.

16. The method of validating an encrypted document as claimed in claim 4, wherein the security key can be merged with the printer commands to be printed out in the form of watermarking.

17. The method of validating an encrypted document as claimed in claim 5, wherein the security key can be merged with the printer commands to be printed out in the form of watermarking.

18. A secured electronic document having a security key, wherein security information presented on the document is compared with the security key saved by a key manager to confirm whether the document is the original copy.

19. The electronic document having a security key as claimed in claim 18, wherein the security key can contain a document identification number given by the document sender.

20. The electronic document having a security key as claimed in claim 18, wherein the security key can contain the serial number of a printer carrying out the printing job.

21. The electronic document having a security key as claimed in claim 18, wherein the security key can contain the printer profile of a printer carrying out the printing job.

22. The electronic document having a security key as claimed in claim 21, wherein the printer profile of the printer may include the frequency of switching of the printer head, the dot resolution, the serial number of the printing paper, and the total output pages.

23. The electronic document having a security key as claimed in claim 19, wherein the security key can be merged with the printer commands to be printed out in the form of uni-dimensional bar codes.

24. The electronic document having a security key as claimed in claim 20, wherein the security key can be merged with the printer commands to be printed out in the form of uni-dimensional bar codes.

25. The electronic document having a security key as claimed in claim 21, wherein the security key can be merged with the printer commands to be printed out in the form of uni-dimensional bar codes.

26. The electronic document having a security key as claimed in claim 22, wherein the security key can be merged with the printer commands to be printed out in the form of uni-dimensional bar codes.

27. The electronic document having a security key as claimed in claim 19, wherein the security key can be merged with the printer commands to be printed out in the form of two-dimensional bar codes.

28. The electronic document having a security key as claimed in claim 20, wherein the security key can be merged with the printer commands to be printed out in the form of two-dimensional bar codes.

29. The electronic document having a security key as claimed in claim 21, wherein the security key can be merged with the printer commands to be printed out in the form of two-dimensional bar codes.

30. The electronic document having a security key as claimed in claim 22, wherein the security key can be merged with the printer commands to be printed out in the form of two-dimensional bar codes.

31. The electronic document having a security key as claimed in claim 19, wherein the security key can be merged with the printer commands to be printed out in the form of watermarking.

32. The electronic document having a security key as claimed in claim 20, wherein the security key can be merged with the printer commands to be printed out in the form of watermarking.

33. The electronic document having a security key as claimed in claim 21, wherein the security key can be merged with the printer commands to be printed out in the form of watermarking.

34. The electronic document having a security key as claimed in claim 22, wherein the security key can be merged with the printer commands to be printed out in the form of watermarking.

35. A method of validating an encrypted document whereby the electronic document is embedded with security information in the printer commands, and, at the same time when the document is printed, a security key is saved to a key manager over the network.

36. The method of validating an encrypted document as claimed in claim 35, wherein the security key can be a document identification number given by the document sender.

37. The method of validating an encrypted document as claimed in claim 35, wherein the security key can be the serial number of a printer carrying out the printing job.

38. The method of validating an encrypted document as claimed in claim 35, wherein the security key can be the printer profile of a printer carrying out the printing job.

39. The method of validating an encrypted document as claimed in claim 38, wherein the printer profile may include the frequency of switching of the print head, the dot resolution, the serial number of the printing paper, and the total output pages of the printer.

40. An electronic document having a security key as claimed in claim 36, wherein the security key can be merged with the printer commands to be printed out in the form of uni-dimensional bar codes.

41. An electronic document having a security key as claimed in claim 37, wherein the security key can be merged with the printer commands to be printed out in the form of uni-dimensional bar codes.

42. An electronic document having a security key as claimed in claim 38, wherein the security key can be merged with the printer commands to be printed out in the form of uni-dimensional bar codes.

43. An electronic document having a security key as claimed in claim 39, wherein the security key can be merged with the printer commands to be printed out in the form of uni-dimensional bar codes.

44. An electronic document having a security key as claimed in claim 36, wherein the security key can be merged with the printer commands to be printed out in the form of two-dimensional bar codes.

45. An electronic document having a security key as claimed in claim 37, wherein the security key can be merged with the printer commands to be printed out in the form of two-dimensional bar codes.

46. An electronic document having a security key as claimed in claim 38, wherein the security key can be can be merged with the printer commands to be printed out in the form of two-dimensional bar codes.

47. An electronic document having a security key as claimed in claim 39, wherein the security key can be merged with the printer commands to be printed out in the form of two-dimensional bar codes.

48. An electronic document having a security key as claimed in claim 36, wherein the security key can be merged with the printer commands to be printed out in the form of watermarking.

49. An electronic document having a security key as claimed in claim 37, wherein the security key can be merged with the printer commands to be printed out in the form of watermarking.

50. An electronic document having a security key as claimed in claim 38, wherein the security key can be merged with the printer commands to be printed out in the form of watermarking.

51. An electronic document having a security key as claimed in claim 39, wherein the security key can be merged with the printer commands to be printed out in the form of watermarking.
